(19) United States
(12) Patent Application Publication
(10) Pub. No.: US 2003/0193582 A1
(43) Pub. Date: Oct. 16, 2003

(54) Method for storing an image, method and system for retrieving a registered image and method for performing image processing on a registered image

(75) Inventor: Naoto Kinjo, Kanagawa (JP)

Correspondence Address: SUGHRUE MION, PLLC, 2100 PENNSYLVANIA AVENUE, N.W., WASHINGTON, DC, 20037, US

(73) Assignee: FUJI PHOTO FILM CO., LTD.

(21) Appl. No.: 10/401,532

(22) Filed: Mar. 31, 2003

(30) Foreign Application Priority Data
Mar. 29, 2002 (JP) 2002-094245

(51) Int. Cl. H04N 5/76

(52) U.S. Cl. 348/231.99; 348/231.2

(57) ABSTRACT

The method for storing an image which obtains pertaining information of an image by using a first database in which a type of an image scene and a sensitivity representation keyword associated therewith are previously stored and stores the image as a registered image together with the pertaining information in a second database, includes extracting a scene in the image and obtaining a type for the image scene when storing the image; deriving the sensitivity representation keyword referring to the first database by using the type obtained; and associating the derived sensitivity representation keyword with the image as the pertaining information thereof and storing the image or its identification information in the second database as the registered image. The method can store an image associated with a sensitivity representation keyword as a registered image, enabling efficient retrieval of the image suitable for a sensitivity representation keyword.

### BACKGROUND OF THE INVENTION

This invention relates to a method for storing a photographed image which stores a photographed image with a camera as a registered image, a read image obtained from a reflective original or a transparent original, or a generated image such as CG (Computer Graphics), a method and a system for retrieving a registered image with which a desired image is retrieved from among the registered images stored with this storage method, and a method for performing image processing on a registered image which extracts an image stored with the method for storing an image or an image retrieved with the method for retrieving a registered image as well as a program for implementing the method for storing an image, a program for implementing the method for retrieving a registered image and a program for implementing the method for performing image processing on a registered image.

Today, there is a need to store images shot with a camera in volume and efficiently retrieve a desired image from among the large quantity of images stored. A variety of retrieval systems have been proposed to satisfy this need.

At the same time, it is desired to efficiently retrieve and output an image suitable for the sensitivity representation of a person who retrieves an image (operator), for example “magnificent” and “fresh” by inputting such a sensitivity representation.

For example, JP 2000-048041 A proposes an image retrieval system whereby a person who retrieves an image can retrieve an image suitable for his/her sensitivity without bearing a burden of checking images.

An image retrieval system according to the patent gazette comprises keyword input means, image input means for inputting an image, image storage means for storing a registered image as well as an image characteristics amount and a keyword, keyword retrieval means for detecting an image using a combination of keywords input from the keyword input means, characteristics amount/keyword extracting means for automatically extracting a keyword and a characteristics amount, and retrieval result narrowing means for narrowing the retrieval result by the keyword retrieval means without using a keyword. This allows a person who retrieves a photographed image to retrieve an image suitable for his/her sensitivity without bearing a burden of checking images.

JP 2001-084274 A proposes a retrieval method which extracts or recognizes specific information present in an image or attached to the image, or present in the image and attached to the image at the same time, store the specific information obtained in a database or store the information related to the specific information in a database as pertaining information attached to the image data of the image, specifies at least part of this pertaining information as a search condition and searches through the database by using the specified search condition, performs matching with pertaining information attached to the selected storage image data thereby reading an image having a degree of matching above a predetermined value. This allows an efficient retrieval of an image.

The image retrieval system according to the JP 2000-048041 A has a problem that it is difficult to uniquely associate an image characteristics amount obtained from a histogram using image characteristics amount calculated per obtained image, for example image data, with a subject in a photographed image which is “vivid” or “magnificent”, thus it is difficult to efficiently retrieve an image suitable for an input sensitivity representation.

The retrieval method according to the JP 2001-084274 A uses specific input information such as voice information and message information instead of a keyword in retrieval and retrieves an image having pertaining information matching or close to the input information. This approach has a problem that the operator must perform cumbersome work of attaching such pertaining information to an image. Moreover, this retrieval method uses a geometric figure to retrieve the area of a subject in a photographed image. In case the subject is a “mountain,” this method retrieves an image having an area of a triangular subject. Thus it is not possible to retrieve an image suitable for a sensitivity representation input by the operator, such as “magnificent” or “fresh”.

### SUMMARY OF THE INVENTION

The invention aims at providing a method for storing an image which eliminates the aforementioned prior art problems and registers a photographed image, obtained image, or generated image to a database as a registered image so as to efficiently retrieve an image suitable for a sensitivity representation keyword associated with the type of a photographed subject or an image scene such as a subject of the image, a method and a system for retrieving a registered image with which an image suitable for a sensitivity representation keyword input by an operator can be efficiently retrieved from among the registered images stored with this storage method, and a method for performing image processing suitable for the input sensitivity representation on a registered image retrieved with this retrieval method as well as a program for implementing the method for storing an image, a program for implementing the method for retrieving a registered image and a program for implementing the method for performing image processing on a registered image.

In order to attain the objects described above, according to a first aspect of the present invention, there is provided a method for storing an image which obtains pertaining information of an image by using a first database in which a type of an image scene and a sensitivity representation keyword associated therewith are previously stored and stores the image or its identification information as a registered image together with the pertaining information in a second database, comprising:

extracting a scene in the image and obtaining a type for the image scene when storing the image;

deriving the sensitivity representation keyword referring to the first database by using the type obtained; and

associating the derived sensitivity representation keyword with the image as the pertaining information thereof and storing the image or its identification information in the second database as the registered image.

Preferably, the type for the image scene of the scene obtained when storing the image is also associated with the registered image as pertaining information of the image.

Preferably, the image is a photographed image, obtained image or generated image, the image scene is a photographed subject or a subject of an image, and the scene is a subject.

Preferably, the type for the photographed subject of the subject obtained when storing the photographed image is also associated with the registered image as pertaining information of the photographed image.

The subject in the photographed image is preferably extracted by using depth information on photographed scene.

After extracting the subject in the photographed image, the subject is preferably identified by using depth information from photographing to obtain the type for the photographed subject of the subject.

The extraction of the subject in the photographed image is preferably extraction of an area of the subject in the photographed image.

In order to attain the above objects, according to a second aspect of the present invention, there is provided a retrieval method for retrieving a desired registered image from among registered images stored by an image storing method which obtains pertaining information of an image by using a first database in which a type of an image scene and a sensitivity representation keyword associated therewith are previously stored and stores the image as a registered image together with the pertaining information in a second database,

the image storing method comprising: when storing the image, extracting a scene in the image; obtaining a type for the image scene; deriving the sensitivity representation keyword referring to the first database by using the type obtained; associating the derived sensitivity representation keyword or the sensitivity representation keyword combined with the type for the image scene with the image as the pertaining information thereof and storing the image or its identification information in the second database as the registered image,

the retrieval method comprising: finding a sensitivity representation keyword that corresponds or approximately corresponds to an input sensitivity representation information or the type of the image scene associated with the sensitivity representation keyword from among the pertaining information of the registered image when retrieving the registered image; and

taking a registered image having the found sensitivity representation keyword or the type of the image scene as the pertaining information out from the second database.

According to the second aspect of the present invention, there is also provided a retrieval method for retrieving a desired registered image from among the registered images stored by an image storing method which obtains pertaining information of an image by using a first database in which a type of an image scene and a sensitivity representation keyword associated therewith are previously stored and stores the image as a registered image together with the pertaining information in a second database,

the image storing method comprising: when storing the image, extracting a scene in the image; obtaining a type for the image scene; deriving the sensitivity representation keyword referring to the first database by using the type obtained; associating the derived sensitivity representation keyword with the image as pertaining information thereof and storing the image or its identification information in the second database as the registered image,

the retrieval method comprising: retrieving the registered image in the second database by using a sensitivity representation keyword that corresponds or approximately corresponds to an input sensitivity representation information when retrieving the registered image;

taking out a plurality of registered images having the sensitivity representation keyword as the pertaining information to display on an image display device;

repeating the procedure of adding points for a predetermined period of time for an image or its type selected by a user from among a plurality of registered images displayed at every retrieval;

totaling the added points per image retrieved with an identical sensitivity representation keyword or per type and per the user after the predetermined period of time has elapsed and storing the resulting total points; and

narrowing the images and their types to those having points exceeding a predetermined rate or giving a priority to those images and types for the next and subsequent retrievals.

In order to attain the above objects, according to a third aspect of the present invention, there is provided a method for performing image processing on a registered image in which image processing is performed on a called-out registered image obtained by retrieving a desired registered image from among registered images stored by an image storing method which obtains pertaining information of an image by using a first database in which a type of an image scene and a sensitivity representation keyword associated therewith are previously stored and stores the image as a registered image together with the pertaining information in a second database,

setting an image processing condition in association with the sensitivity representation keyword;

storing by the image storing method which, when storing the image, extracts a scene in the image and obtains a type for the image scene, derives the sensitivity representation keyword referring to the first database by using the type obtained, associates the derived sensitivity representation keyword or the sensitivity representation keyword combined with the type for the image scene with the image as the pertaining information thereof and stores the image or its identification information in the second database as the registered image;

when retrieving the registered image, finding a sensitivity representation keyword that corresponds or approximately corresponds to an input sensitivity representation information or the type of the image scene associated with the sensitivity representation keyword from among the pertaining information of the registered image;

taking a registered image having the found sensitivity representation keyword or the type of the image scene as the pertaining information out from the second database;

when performing image processing on the taken registered image, calling an image processing condition associated with a sensitivity representation keyword that corresponds or approximately corresponds to the sensitivity representation information; and

performing the image processing according to the image processing condition.

According to the third aspect of the present invention, there is also provided a method for performing image processing on a registered image in which image processing is performed on a called-out registered image obtained by retrieving a desired registered image from among registered images stored by an image storing method which obtains pertaining information of an image by using a first database in which a type of an image scene and a sensitivity representation keyword associated therewith are previously stored and stores the image as a registered image together with the pertaining information in a second database,

setting an image processing condition in association with the sensitivity representation keyword;

storing by the image storing method which, when storing the image, extracts a scene in the image and obtains a type for the image scene, derives the sensitivity representation keyword referring to the first database by using the type obtained, associates the derived sensitivity representation keyword with the image as the pertaining information thereof and stores the image or its identification information in the second database as the registered image;

when retrieving the registered image, retrieving the registered image in the second database by using a sensitivity representation keyword that corresponds or approximately corresponds to an input sensitivity representation information;

taking out a plurality of registered images having the sensitivity representation keyword as pertaining information to display on an image display device;

repeating the procedure of adding points for a predetermined period of time for an image or its type selected by a user from among a plurality of registered images displayed at every retrieval;

totaling the added points per image retrieved with an identical sensitivity representation keyword or per type and per the user after the predetermined period of time has elapsed and storing the resulting total points;

narrowing the images and their types to those having points exceeding a predetermined rate or giving a priority to those images and types for the next and subsequent retrievals;

when performing an image processing on the retrieved registered image, calling an image processing condition associated with a sensitivity representation keyword that agrees or approximately agrees with the sensitivity representation information; and

performing the image processing according to the image processing condition.

In order to attain the above objects, according to a fourth aspect of the present invention, there is provided a system for storing an image, comprising:

a first database which previously stores a type of an image scene and a sensitivity representation keyword associated therewith;

means for obtaining a type for the image scene by extracting a scene in the image when the image is stored;

means for deriving the sensitivity representation keyword referring to the first database by using the type obtained; and

a second database which associates the derived sensitivity representation keyword or the sensitivity representation keyword combined with the type for the image scene with the image as the pertaining information thereof and stores the image or its identification information as the registered image together with the pertaining information.

Preferably, the type for the image scene of the scene obtained when storing the image is also associated with the registered image as pertaining information of the image.

Preferably, the image is a photographed image, obtained image or generated image, the image scene is a photographed subject or a subject of an image, and the scene is a subject.

Preferably, the type for the photographed subject of the subject obtained when storing the photographed image is also associated with the registered image as pertaining information of the photographed image.

The subject in the photographed image is preferably extracted by using depth information on photographed scene.

After extracting the subject in the photographed image, the subject is preferably identified by using depth information from photographing to obtain the type for the photographed subject of the subject.

The extraction of the subject in the photographed image is preferably extraction of an area of the subject in the photographed image.

In order to attain the above objects, according to a fifth aspect of the present invention, there is provided a retrieval system for retrieving a desired registered image from among registered images, comprising:

a first database in which a type of an image scene and a sensitivity representation keyword associated therewith are previously stored;

means for obtaining a type for the image scene by extracting a scene in the image when storing the image;

means for deriving the sensitivity representation keyword referring to the first database by using the type obtained;

a second database which associates the derived sensitivity representation keyword or the sensitivity representation keyword combined with the type for the image scene with the image as the pertaining information thereof and stores the image or its identification information as the registered image together with the pertaining information; and

registered image retrieval means which finds a sensitivity representation keyword that corresponds or approximately corresponds to an input sensitivity representation information or the type of the image scene associated with the sensitivity representation keyword from among registered images and their pertaining information stored in the second database, and takes a registered image having the found sensitivity representation keyword or the type of the image scene as the pertaining information out from the second database.

According to the fifth aspect of the present invention, there is also provided a retrieval system for retrieving a desired registered image from among registered images, comprising:

a first database in which a type of an image scene and a sensitivity representation keyword associated therewith are previously stored;

means for obtaining a type for the image scene by extracting a scene in the image when storing the image;

means for deriving the sensitivity representation keyword referring to the first database by using the type obtained;

a second database which associates the derived sensitivity representation keyword or the sensitivity representation keyword combined with the type for the image scene with the image as the pertaining information thereof and stores the image or its identification information as the registered image together with the pertaining information;

retrieval means which retrieves the registered image in the second database by using a sensitivity representation keyword that corresponds or approximately corresponds to an input sensitivity representation information when the registered image is retrieved from registered images stored in the second database;

an image display device which takes out and displays a plurality of registered images having the sensitivity representation keyword as the pertaining information; and

evaluation means which repeats the procedure of adding points for a predetermined period of time for an image or its type selected by a user from among the plurality of registered images displayed at every retrieval, totals the added points per image retrieved with an identical sensitivity representation keyword or per type and per the user after the predetermined period of time has elapsed, and stores the resulting total points in the second database as the pertaining information of the registered image, wherein

the retrieval means narrows the images and their types to those having points exceeding a predetermined rate or giving a priority to those images and types for the next and subsequent retrievals.

In order to attain the above objects, according to a sixth aspect of the present invention, there is provided a system for performing image processing on a registered image, comprising:

a retrieval system for retrieving a registered image according to the fifth aspect of the present invention;

a third database which sets image processing conditions in association with sensitivity representation keywords; and

image processing means which calls the registered image retrieved from the second database by the retrieval system, calls an image processing condition associated with a sensitivity representation keyword that corresponds or approximately corresponds to the sensitivity representation information when the image processing is to be performed on the called registered image, and subjects the registered image to the image processing based on the image processing condition.

In order to attain the above objects, according to a seventh aspect of the present invention, there are provided a program with which the method for storing an image according to the first aspect of the invention is implemented, a program with which the retrieval method for retrieving a registered image according to the second aspect of the invention is implemented, and a program with which the method for performing image processing on a registered image according to the third aspect of the invention is implemented.

### BRIEF DESCRIPTION OF THE DRAWINGS

FIG. 1 is a block diagram showing a general configuration of an embodiment of an image storage/retrieval unit which executes the image storage method of the invention;

FIG. 2 is a flowchart showing an example of the flow of the image storage method of the invention implemented in the image storage/retrieval unit shown in FIG. 1;

FIG. 3 is a flowchart showing an example of the flow of the registered image retrieval method for retrieving a registered image and a method for performing image processing on a registered image;

FIG. 4 is an explanatory drawing which provides an easy-to-understand explanation of the information associated with a photographed image in the image storage method of the invention; and

FIG. 5 is an explanatory drawing explaining the correspondence of the type of a photographed subject used by the method for retrieving a registered image of the invention and a sensitivity representation keyword.

### DETAILED DESCRIPTION OF THE INVENTION

A method for storing an image, a method and a system for retrieving a registered image, a method for performing image processing on a registered image and programs for implementing these methods according to the invention are described below in detail with reference to preferred embodiments shown in the accompanying drawings.

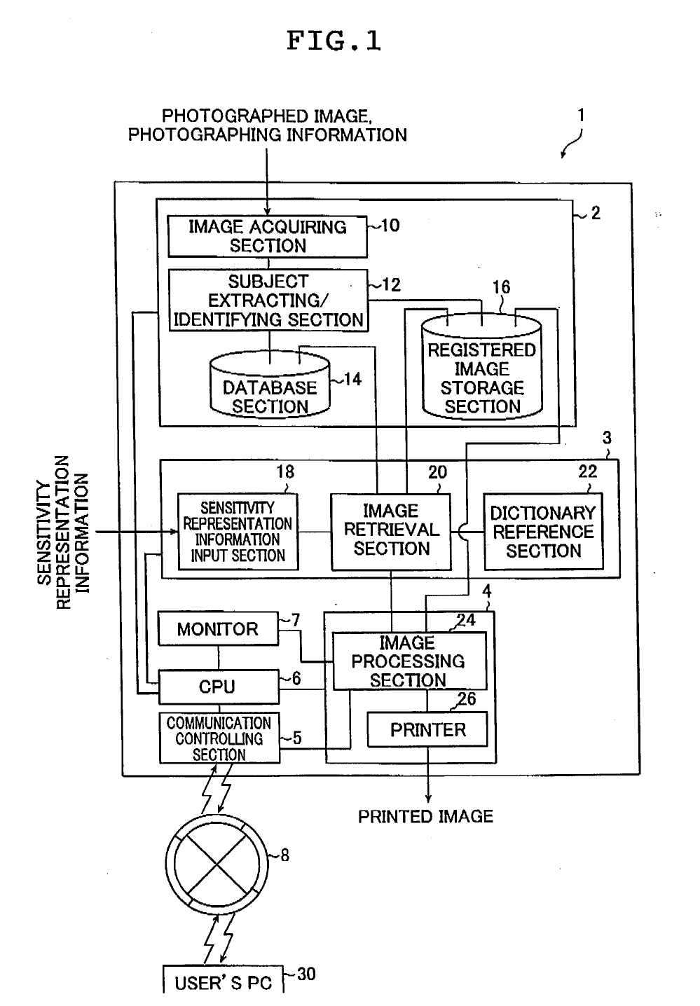

While the following description is based on an image retrieval/image processing unit 1 shown in FIG. 1 as an embodiment of a unit implementing the methods of the invention, that is, the method for storing an image according to a first aspect of the present invention, the method for retrieving a registered image according to a second aspect of the present invention and the method for performing image processing on a registered image according to a third aspect of the present invention, this invention is not limited to this embodiment.

FIG. 1 is a block diagram functionally showing a general configuration of an image retrieval/image processing unit 1.

The image retrieval/image processing unit 1 may be partially a computer which exercises its function by executing a program or partially a dedicated circuit or a computer and a dedicated circuit.

The image retrieval/image processing unit 1 is a unit which retrieves an image based on sensitivity representation information such as “magnificent” and “vivid” (hereinafter referred to as sensitivity representation information) input by an operator, performs image processing on a desired image, and outputs the resulting image as a photographic print.

The image retrieval/image processing unit 1 mainly comprises an image storage unit 2, an image retrieval unit 3, an image output unit 4, a communications controller 5, a CPU 6 and a monitor 7.

The CPU 6 is a section controlling respective functions of the image storage unit 2, the image retrieval unit 3, the image output unit 4, and the communications controller 5.

The image retrieval/image processing unit 1, the image storage unit 2, and the image storage unit 2 combined with the image retrieval unit 3 constitute a system for performing image processing on a registered image according to a sixth aspect of the invention, a system for storing an image according to a fourth aspect of the invention, and a system for retrieving a registered image according to a fifth aspect of the invention.

The image storage unit 2 is a unit for storing a sensitivity representation keyword suitable for a registered image as pertaining information associated with the registered image when a photographed image with a digital still camera and so on is stored as the registered image.

The image storage unit 2 comprises an image acquiring section 10, a subject extracting/identifying section 12, a database 14, and a registered image storage section 16.

The image acquiring section 10 is a section for acquiring a photographed image with a digital still camera. Or, the image acquiring section 10 may be scanner which reads an image formed on a photo-receiving surface such as that of a CCD (Charge-Coupled Device) by using a transmitted light. The image acquiring section 10 further acquires shooting information in shooting, for example a shooting location (latitude and longitude), bearing of shooting and shooting magnification, as well as shooting date/time information and information on ranging from a camera to a subject in shooting, when acquiring an image being photographed. The information on the shooting location and bearing of shooting is acquired which is recorded when shooting is made with a camera equipped with the GPS (Global Positioning System) function and a bearing measurement sensor using a gyrocompass. The ranging information is acquired which is measured and recorded by a measurement sensor for measuring a distance from a camera to a subject by using an infrared ray, etc.

The method for acquiring shooting information for a digital camera is such that data on shooting information is read when image data is read into the image acquiring section 10. For a camera using the APS (Advanced Photo System) silver halide film, shooting information is written into magnetic recording areas provided in top and bottom sections of each shooting frame. The shooting location and bearing of shooting can be acquired when the magnetic recording information written into the magnetic recording areas is read by a magnetic reader provided on a scanner while shooting image is being read by the scanner.

The image acquiring section 10 may acquire an image in a web site on a communications network 8 such as the internet connected via the communications controller 5.

The subject extracting/identifying section 12 extracts a subject in an image by using shooting information from the image acquired by the image acquiring section 10. Further, the subject extracting/identifying section 12 is a section for identifying the subject in the extracted area and obtaining the type of the photographed subject, such as “portrait,” “mountain,” “sea,” “forest,” or “Mt. Fuji” from the extracted subject, extracted area, or identified subject.

For extraction of the area of the subject, an area where the edge of a subject is sharp is extracted for example by performing differentiation on the acquired image. The focused area has a sharp edge and the corresponding value is increased through differentiation.

When a subject is photographed with a camera oriented in a same direction in a same location, multi-stage focus images are obtained by shooting a plurality of images of a subject at multi-stage image forming distances (distances from the principal point of the image forming lens of the camera to the image forming surface). Then, by using the ranging information obtained in shooting and information on the image forming distance acquired together with the multi-stage focus images, the area of the subject in the shooting scene can be extracted. Also, the depth information of the shooting scene can be obtained. In particular, the ranging information is a distance from the camera for shooting and the subject. Thus, an area where a focus is achieved in the photographed image at an image forming distance identical with or closest to the image forming distance corresponding to the distance information is obtained. This area can be extracted as the area of the subject. Thus, an area where the focus of the photographed image is achieved at another image forming distance can be acquired as depth information. The focus-achieved area can be obtained through differentiation as mentioned above.

This depth information can be used to identify a subject, as mentioned later.

A subject is identified by using the above-mentioned shooting location (latitude and longitude), bearing of shooting and shooting magnification as well as map data owned by the subject extracting/identifying section 12. For example, a subject is identified by extracting a candidate for the subject in the map data from the shooting location and bearing of shooting and associating the shape and size of the subject in the photographed image with the three-dimensional information as a candidate for the subject in the map data. In this case, use of the above-mentioned depth information upgrades the accuracy of identification.

The subject extracting/identifying section 12 further obtains the type of a photographed subject based on an extracted subject area or an identified subject. For example, common nouns such as “liver” and “sea” and proper nouns such as “Mt. Fuji” and “Tokyo Tower” are obtained.

The type of a common noun such as a blue “sea” and a white “mountain” may be obtained by directly extracting the subject or extracting the subject area and using the image data in this area, instead of identifying the subject.

The subject extracting/identifying section 12 then uses the correspondence between the type of a photographed subject and a sensitivity representation keyword stored in the database 14 to derive the sensitivity representation keyword.

The database 14 is a section corresponding to a first database of the invention and records/stores the type of a photographed subject mentioned earlier and a sensitivity representation keyword associated with the type.

For example, the types “sea,” “lake,” or “sky” is associated with the sensitivity representation keyword “vivid” while “forest” the sensitivity representation keyword “fresh” and the proper noun “Mt. Fuji” the sensitivity representation keyword “magnificent.” A plurality of sensitivity representation keywords may be associated with a single type. A plurality of types may be associated with a single sensitivity representation keyword.

In the method for associating the type of a photographed subject with a sensitivity representation keyword in the database 14, the subject of the image or theme of the scene may be manually or automatically set, or both. Association of a sensitivity representation keyword may be separate from derivation of the type of a subject.

For example, derivation of the type of a subject is possible through computer graphics (CC) as well as from a photographed image, since what counts is the main theme of the image.

An image to which the present invention is applied may be, in addition to a photographed image, a read (scanned) image obtained from a reflective original/transparent original or a generated image such as a CG image. Further, each of the photographed image, a read image and a generated image may be a televised image or the like. Whether an image is a motion image or a still image, the present invention can be applied to various types of image data.

Furthermore, an image scene may be a photographed subject or a subject of an image, a scene information may be a photographing information or a subject information, and a scene may be a subject.

In case data indicating a subject is found in the meta data including picture contents such as television broadcasts, it is possible to separately generate data used to retrieve a sensitivity representation on an agent level and/or user level. For example, in case the subject person is a television personality or a celebrity, it is possible to access the latest image survey data of the person and attach and/or update a sensitivity representation keyword. In this case, personal computer (PC) software is preferably provided by a specialized agent to allow a general user to carry out this processing.

In this example, the type of a subject and an input keyword are preferably associated with each other and stored into the database 14 when the image is displayed on a display device and a keyword to indicate the impression is input and/or selected.

A sensitivity representation keyword derived by the subject extracting/identifying section 12 is sent to the registered image storage section 16 together with the photographed image.

The registered image storage section 16 is a section corresponding to a second database of the invention and stores a photographed image as a registered image while associating as pertaining information a derived sensitivity representation keyword with the registered image.

The image retrieval unit 3 comprises a sensitivity representation information input section 18, an image retrieval section 20 and a dictionary reference section 22. The image retrieval unit 3 retrieves a registered image from the registered image storage section 16 suitable for sensitivity representation information, for example “fresh” input by an operator.

The sensitivity representation information input section 18 is an input unit such as a keyboard and a mouse for inputting sensitivity representation information. The sensitivity representation information input section 18 sends the sensitivity representation information to the image retrieval section 20.

The image retrieval section 20 compares the sensitivity representation information received with a sensitivity representation keyword stored in the registered image storage section 16 and checks for a matching sensitivity representation keyword. If a sensitivity representation keyword matching the input sensitivity representation information, the image retrieval section 20 extracts the registered image associated with the sensitivity representation keyword from the registered image storage section 16 and sends the registered image together with the matching sensitivity representation keyword to an image processor 24 mentioned later.

In case a sensitivity representation keyword matching the input sensitivity representation information is not found, the image retrieval section 20 sends the sensitivity representation information to the dictionary reference section 22 and instructs the dictionary reference section 22 to derive an approximate representation of the sensitivity representation information. When the approximate representation of the sensitivity representation information is sent from the dictionary reference section 22, the image retrieval section 20 checks for a sensitivity representation keyword matching the approximate representation. For example, an approximate representation of the sensitivity representation information “refreshing” is “fresh.” When a sensitivity representation keyword matching an approximate representation is found, the image retrieval section 20 extracts a registered image associated with the sensitivity representation keyword from the registered image storage section 16 and sends the registered image together with the matching sensitivity representation keyword to the image processor 24.

In case an approximate representation matching the sensitivity representation keyword is not found ultimately, it is assumed that a registered image matching the sensitivity representation information has not been found and processing in the image output unit 4 does not take place.

The dictionary reference section 22 is a section for deriving an approximate representation of sensitivity representation information sent from the image retrieval section 20 by referring to the built-in dictionary. A plurality of approximate representations may be derived in the descending order of approximation to the sensitivity representation, or an approximate representation may be derived one at a time in the descending order of approximation to the sensitivity representation.

The image output unit 4 comprises an image processor 24 and a printer 26.

The image processor 24 is a section for performing image processing on a registered image sent from the image retrieval section 20. The processing details of the image processing, that is, the image processing conditions are provided in association with sensitivity representation keywords and stored in a third database. The third database is preferably provided in the image processor 24 but may be the database 14 or registered image storage section 16, or a separate database or memory (data recording section). In case the third database is the database 14, the image processing conditions may be stored in association with sensitivity representation keywords together with types of subjects, or may be separately stored as long as they are associated with the sensitivity representation keywords.

Thus, the image processor 24 calls the image processing conditions from the third database based on a sensitivity representation keyword sent from the image retrieval section 20, and performs image processing on the registered image based on the image processing conditions.

The image processor 24 does not output a registered image as it is but performs image processing so as to tailor the image to the sensitivity representation keyword matching or approximate to the sensitivity representation information in retrieval.

For example, the image processor 24 intentionally scales up/down the geometric characteristics (size and shape), processes the image density or hue, or performs modification such as emphasis of sharpness and blurring. The image processing conditions may vary between the type of a photographed subject.

For example, in case the sensitivity representation keyword is “vivid,” the image processor 24 performs image processing to increase to chroma on an area in the registered image having a chroma above a predetermined threshold of the registered image. An example of this is a case where the type of the subject of a registered image is “flower.” In case the type of the subject is “sky” or “sea,” the image processor 24 increases the chroma of the blue color.

In case the sensitivity representation keyword is “magnificent” or “sublime,” and the type of the subject of a registered image is “mountain,” the image processor 24 magnifies the size of the subject to increase the magnificence or sublimity. In this case, the image processor 24 does not change the size of the person in the foreground and performs interpolation on the gap between the person and the mountain in the background.

The image processor 24 increases the contrast or sharpness of the area of “mountain” in the registered image. For a snow-covered mountain, the image processor 24 performs color correction to emphasize the while snow and blurs the image elsewhere than the area of “mountain.” In case the sensitivity representation keyword is “nostalgic,” the image processor 24 performs image processing on the registered image in a sepia tine.

In case the sensitivity representation keyword is “beautiful” and the type of the subject of a registered image is “female,” the image processor 24 enlarges the area of “female” in the registered image without changing the Size of the area of background. The image processor 24 also blurs the area of background.

In this way, the image processing conditions are determined in association with a sensitivity representation keyword matching or approximate to the sensitivity representation information the operator input from the sensitivity representation information input section 18. Thus, a same registered image has different sensitivity representation keywords depending on the input sensitivity representation information and the resulting different image processing. The image processor 24 may be configured by a dedicated circuit (hardware) or function via execution of a program (software).

The printer 26 is an image output unit for outputting a registered image which has undergone image processing in order to provide a registered image image-processed in the image processor 24 as a print image. The printer 26 may be an ink-jet printer or a printer where a photosensitive material is exposed to laser beams for printing.

The printer 26 is a form of outputting a registered image which has undergone image processing. The registered image processed in the image processor 24 may be displayed on the monitor 7, sent to the communications controller 5 and then sent to a user's PC (Personal Computer) 30 via the communications network 8 such as the internet. The image-processed registered image may be stored onto a recording medium such as an MO, CD-R, Zip(TM) and a flexible disk.

This is the end of the description of the basic configuration of the image retrieval/image processing unit 1.

The method for storing an image, the method for retrieving a registered image and the method for performing image processing on a registered image according to the invention implemented in the image retrieval/image processing unit 1 are described below.

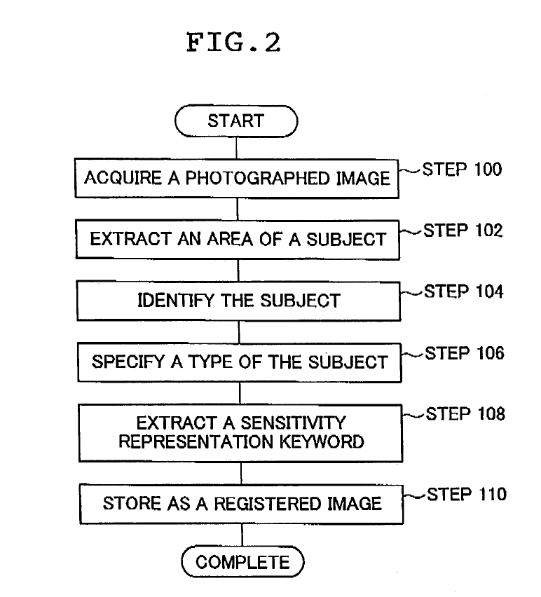

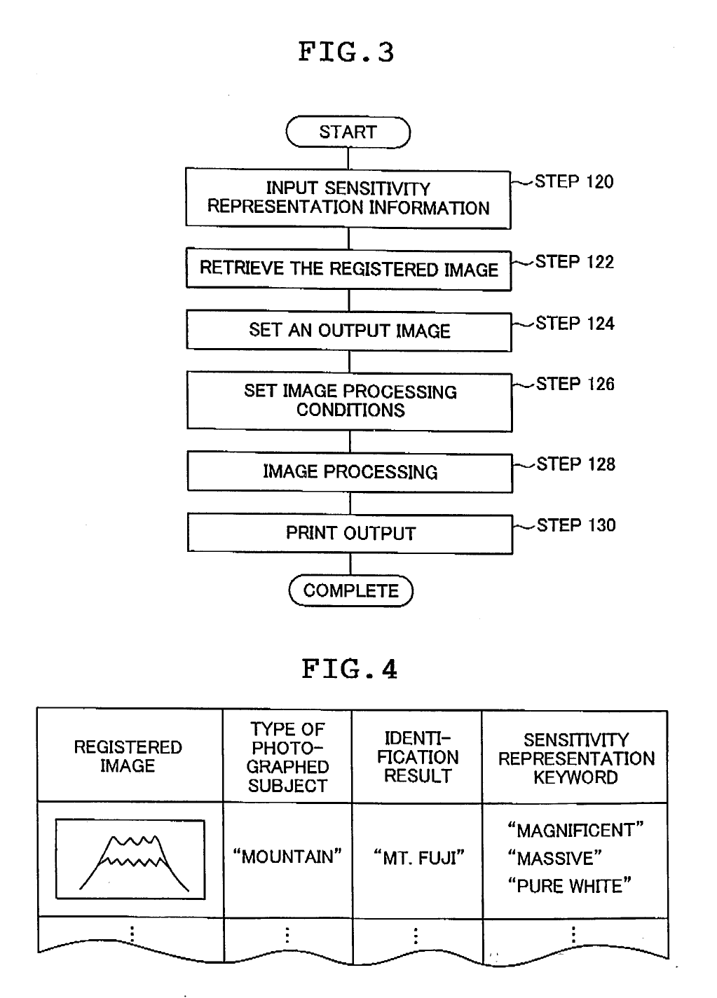

FIG. 2 is an exemplary flowchart of the image storage method according to the first embodiment of the invention. FIG. 3 is an exemplary flowchart of the registered image retrieval method according to the second embodiment of the invention and the method for performing image processing on a, registered image according to the third embodiment of the invention. FIG. 4 is an explanatory drawing which provides an easy-to-understand explanation of the information associated with a photographed image in the image storage method according to the first embodiment of the invention.

In the image storage method according to the first embodiment of the invention, a photographed image is acquired by the image acquiring section 10 as shown in FIG. 2 (step 100).

Acquisition of a photographed image may be made via direct transfer from a digital still camera. Or, a photographed image with a digital still camera may be acquired via a recording medium or transferred from the user's PC 30 via the communications controller 5. Or, a photographed image recorded on a silver halide film may be photoelectrically read by a scanner.

At the same time as the photographed image is acquired, information on the shooting location (latitude and longitude), bearing of shooting and shooting magnification, as well as shooting date/time information and information on ranging from a camera to a subject in shooting is acquired.

Next, the subject itself or the area of the subject is extracted in the subject extracting/identifying section 12 (step 102).

For example, the photographed image acquired undergoes differentiation and is extracted as an area where the edge section as a subject is sharpened. In case Mt. Fuji is photographed as a subject, the edge section of Mt. Fuji is extracted as an area. Extraction of such a subject area is given scores so that an area closer to the center of a photographed image or a larger area will be given a higher score in case a plurality of areas are found, and the area with the highest score is extracted as the area of the subject.

Next, the extracted subject or area of the subject is identified (step 104). For example, in case the shooting information includes the information on the shooting location (latitude and longitude), bearing of shooting and shooting magnification, a candidate for the subject in the map data is extracted from the location and shape of the subject (shape of the area of the subject) in the photographed image and the shooting magnification are used to associate the shape, size and location of the subject in the photographed image with the three-dimensional information as a candidate for the subject, thereby identifying the subject. In case multi-stage focus images are obtained by shooting a plurality of images of a subject at multi-stage image forming distances with a camera oriented in a same direction in a same location, the information on the depth of the shooting scene is obtained. The information on the depth of the shooting scene can be used to upgrades the accuracy of identification.

Next, the type of a subject is obtained (step 106).

For example, in case an extracted or identified subject is “Mt. Fuji,” the type “mountain” is obtained.

Next, a sensitivity representation keyword associated with the type “mountain” is derived from the previously provided database 14 (step 103) and associated with the photographed image.

Finally, the photographed image is associated with the extracted sensitivity representation keyword, and stored into the registered image storage section 16 (step 110).

In FIG. 4, sensitivity representation keywords such as “magnificent,” “massive,” and “pure white” are associated with the photographed image of “Mt. Fuji.” In the method for storing a photographed image, in case the shooting date and time are included in the shooting information, the event information and weather information of the shooting date/time can be identified. The type of a subject may be limited by weather information.

For example, in the case of a photographed image of “Mt. Fuji,” the type “mountain on a clear day” is determined in case the weather is fine judging from the weather information in shooting. The type “mountain on a rainy day” is determined in case the weather is rainy. The associated with keyword “refreshing” is associated with the “mountain on a clear day” and the associated with keyword “damp” is associated with the “mountain on a rainy day” then these combinations are stored in the database 14 in advance. If the shooting date/time is in autumn, the sensitivity representation keyword “vivid” or “pretty” is associated with the scarlet-tinged “autumn forest.”

Further, event information in the shooting location is known from the shooting date/time. For example, the sensitivity representation keyword “lively” or “cheerful” may be associated with the type “festival.” Or, the sensitivity representation keyword “radiant” may be associated with each of the event types “entrance ceremony,” “graduation ceremony,” and “coming-of-age celebration.”

Such association of a type and a sensitivity representation keyword is generated and stored into the database 14.

The registered image thus stored/recorded into the database 14 is accessed by the image retrieval unit 3 and undergoes retrieval of registered images.

First, an operator input sensitivity representation information from the sensitivity representation information input section 18 (step 120). For example, when the sensitivity representation information such as “sublime” is input, the sensitivity representation information is sent to the image retrieval section 20.

The image retrieval section 20 compares the sensitivity representation information sent with sensitivity representation keywords, and checks whether a sensitivity representation keyword matching the sensitivity representation information is stored in the database 14. For example, the image retrieval section 20 checks whether a sensitivity representation keyword such as “sublime” is stored.

In case a matching sensitivity representation keyword is not found, the sensitivity representation information is sent to the dictionary reference section 22. The dictionary reference section 22 derives a representation approximate to the sensitivity representation information sent. As an approximate representation, for example an approximate representation with higher approximation is derived and sent to the image retrieval section 20. For example, the approximate representation “magnificent” is derived for the sensitivity representation information “sublime” and returned to the image retrieval section 20.

The image retrieval section 20 uses the returned approximate representation to access the registered image storage section 16 and checks whether a sensitivity representation keyword matching the approximate representation is stored.

In the registered image storage section 16, the photographed image of “Mt. Fuji” is associated with the associated with keywords “magnificent,” “massive,” and “pure white” as pertaining information of the photographed image. The associated with keyword “magnificent” is found to match the approximate representation “magnificent.” Thus, the registered image of “Mt. Fuji” having the sensitivity representation keyword as pertaining information is extracted. A registered image is retrieved in this way (step 122).

A registered image having a sensitivity representation keyword matching or approximate to sensitivity representation information is retrieved as mentioned above. In case a plurality of registered images are retrieved as a result of retrieval, the retrieved images are displayed on the monitor 7 and selection of output of a registered image is made by the operator, as mentioned later. Thus the output image is set (step 124). While the following example uses case where a print image is output, the invention is not limited to this example.

The registered image set as an output image is sent to the image processor 24 together with the above sensitivity representation keyword matching or approximate to the sensitivity representation information.

The image processor 24 determines image processing conditions in accordance with the sensitivity representation keyword sent from the image retrieval section 20 (step 126) and performs image processing based on the image processing conditions (step 128).

In the image processor 24, the processing conditions are uniquely associated with sensitivity representation keywords and stored in the third database, so that the image processing conditions are determined in accordance with a sensitivity representation keyword. The image processing conditions are associated with sensitivity representation keywords and variable depending on the sensitivity representation information input by the operator. Thus, the same registered image has different image processing conditions depending on the input sensitivity representation information.

For example, assume the image processing conditions where the area of a mountain as a subject is enlarged without changing the center of the area in response to the sensitivity representation keyword “magnificent” is stored in a database, and the image processing conditions where a slightly stained white area of a mountain as a subject is determined as snow and converted to a while area with high lightness is stored in the database. When the sensitivity representation information “sublime” is input, “Mt. Fuji” is enlarged and emphasized in the former case. When the sensitivity representation information “pure white” is input, the area of snow of Mt. Fuji is emphasized with pure white.

The registered image which has undergone image processing is converted to data suitable for the printer 26, which outputs the image as a print image (step 130).

Depending on the output form selected, the registered image which has undergone image processing is sent to the user's PC 30. Or, the image is written onto a recording medium such as an MO, CD-R, Zip(TM) and a flexible disk.

In this way, according to this embodiment, a registered image suitable for the sensitivity representation information input by the operator is retrieved and the registered image is emphasized when it is output in accordance with the sensitivity representation information.

While the database 14 of the embodiment previously stores the types of sot subjects and sensitivity representation keywords associated with the types, the database may be databases dedicated to respective individuals in this invention. For example, a plurality of sample images and a list of sensitivity representation keywords are provided in advance and each individual selects a sensitivity representation keyword per sample image from the sensitivity representation keyword list to obtain the correspondence between the types of photographed subjects of sample images and sensitivity representation keywords and stores the combinations into the database. This develops each personal database.

While a sensitivity representation keyword is associated with a registered image as pertaining information and stored when a photographed image is stored into the registered image storage section 16 as a registered image in this embodiment, the type of a subject obtained by extracting the area of the subject from the photographed image may be stored as pertaining information of the registered image in the registered image storage section 16 in association with the registered image. This allows retrieval of a registered image using the following method in step 122 shown in step 3.

In retrieval of an image, a sensitivity representation keyword matching or approximate to sensitivity representation information input in step 120 is checked in the database 14. In the absence of a sensitivity representation keyword matching or approximate to the sensitivity representation information, the image retrieval section 20 instructs the dictionary reference section 22 to derive an approximate representation and uses the approximate representation to check sensitivity representation keywords in the database 14. When it finds a sensitivity representation keyword or approximate to the sensitivity representation information in the database 14, the image retrieval section 20 extracts the type of an associated photographed subject. Then the image retrieval section 20 extracts the type as pertaining information matching the type of the extracted photographed image. In this way, it is possible to retrieve a registered image having the type matching the type of the shit subject as pertaining information. In this practice, a sensitivity representation keyword matching or approximate to the sensitivity representation information is preferably included in a plurality of sensitivity representation keywords owned by the registered image as pertaining information.

The registered image storage section 16 may stored the history of the date/time the registered image is retrieved, in association with the registered image. For example, it is possible to retrieve a registered image based on the memory of the date/time retrieval was made.

Further, a voice recording unit may be provided in the neighborhood of the monitor 7 and the speech details of a viewer of a registered image given when the retrieved registered image is displayed on the monitor 7 may be recorded and the speech details may be stored in association with the registered image as pertaining information of the registered image. The sensitivity representation information input section 18 is provided with a voice input system for the viewer to retrieve, at a later date, a registered image having the speech details as pertaining information by inputting the sensitivity representation information via voice input based on the memory of the speech details.

Such retrieval may be combined with the retrieval method of the embodiment for more efficient retrieval of a desired registered image. The image retrieval and image processor used in the invention also provides entertainment whereby for example a soothing image or a refreshing image is displayed.

While a subject or scene as a target for registration/storage of a photographed image, retrieval of a registered image and image processing is scenery in the embodiment, the invention is not limited to this specific embodiment.

For example, a target subject or scene may be a person, a person's belongings or an article close to the person.

In this case, association of the types of photographed subjects with sensitivity representation keywords is made as described below.

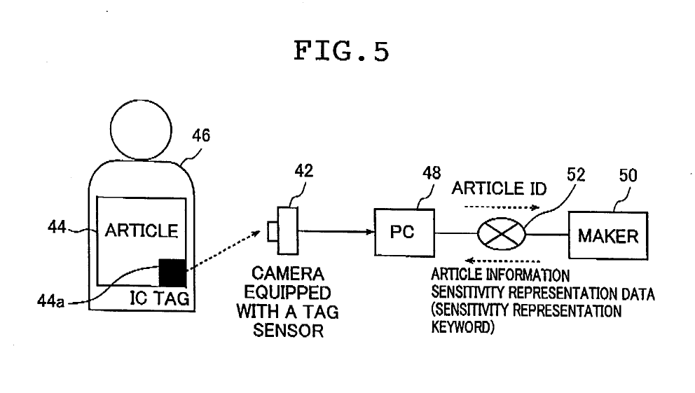

Referring to the embodiment shown in FIG. 5, when a person 46 having a an article equipped with an IC tag 44a, for example a handbag or wearing an ornament or clothes is photographed with a digital camera 42 equipped with a tag sensor, a photographed image of the person 46 as well as the identification data (article ID) of the handbag, ornament and clothes as the type of the photographed subject is obtained.

After the image is photographed, the camera 42 is connected to the PC (Personal Computer) 48 and the article ID obtained is input to the PC 48 together with the image data. An access is made using the article ID as a key from the PC 48 to a maker 50 via a communications network 52. The article information on the article 44 provided by the maker 52 and the sensitivity representation keyword are captured. The sensitivity representation keyword captured may be associated with the article 44 (type) and stored into a database (for example the database 14 in FIG. 1). The image data of the person and the article may be associated with a sensitivity representation keyword, or preferably with a type (article data) and stored into the database (registered image storage section 16).

The belongings of the person or the article 44 positioned in close proximity of the person in shooting are used as the type of a photographed subject and includes the ornaments, clothes, handbags, shoes, hats and ornaments for the alcove and furniture. A single type or plurality of types of a photographed image may be used.

The maker 50 provides sensitivity representation data serving as article information and a sensitivity representation keyword in associated with the article ID of the article 44. For example, in case the article 44 is kimono, the sensitivity representation data “bewitching” is provided for the kimono whose article XD is “XXX1 While the sensitivity representation data “tasteful” is provided for the kimono whose article ID is “XXX2.”

In the first step of associating the type of a photographed subject other than scenery with a sensitivity representation keyword, image data includes subject information as pertaining information. The subject information may be information on a person or can be read from an IC tag attached to each article such as the belongings of the person and ornaments close to the person.

In the second step, a sensitivity representation is read from a database and added to the pertaining information of the image data. In this case, a plurality of sensitivity representations may be associated with a single article in the order of priority.

An image as a target in the invention may be a moving picture as well as a still picture.

While the image data of a photographed image and a keyword are stored into a database (registered image storage section 16) in association with each other in the embodiment, the invention is not limited to this embodiment. In the invention, at least relationship between the image data and a sensitivity representation keyword must be specified, so that a sensitivity representation keyword need not be attached to the image data. For example, A file where the ID of image data (file name, access destination, etc.) is attached to each sensitivity representation keyword may be recorded (data addition, update and deletion are available) for reference.

Association of sensitivity representation information with a target for retrieval may incorporate a learning function for customized learning of the association per individual user.

The input step is as follows assuming that the user retrieves a desired image as a background image (so-called wallpaper) of a PC desktop.

When a first specific keyword is input or selected, a plurality of images are displayed sequentially or as index images. When a user's favorite image (or images) is selected, points are added to the selected image and the selected image is displayed as wallpaper for a predetermined period (one day/one week). In case a plurality of images are selected, the image on the desktop is preferably updated sequentially.

When the predetermined period has elapsed, a sensitivity representation keyword is used to retrieve and select an image (images).

In the next learning step, distribution of points is checked for an image retrieved using the same sensitivity representation keyword after a predetermined period has elapsed.

Here, points are totaled per type of a subject in each image. A plurality of types may be associated with a single subject. In this case, points are added per each of the types of the subject.

For example, two or more types may be associated with a single subject. A proper noun, a field or a country name, or some-thousand-meter-class mountain for a mountain, sex, age, or occupation for a person may be specified.

Example 1: “proper noun: Mt. Fuji,” “field: mountain,” “country name: Japan,” “height: 3000-m class,” “popularity: great”

Example 2: “proper noun: XX,” “field: person,” “country name: Japan, “sex,” “age bracket,” “occupation: actor”

Added points are totaled per type and the total point result is stored per user. The total point result is registered in the PC as customized information for retrieval.

In the next round of retrieval, an image is retrieved and displayed by narrowing the types to those having points exceeding a predetermined rate or by giving the priority to those points. For example, assigning points per type may be repeated to a certain extent and the type which has acquired the largest number of points may be given a high priority.

In this practice, different images are retrieved for Mr. A and Mr. B even when a same sensitivity representation keyword is used. For example, a hit is found in a natural scene, especially a forest scene for Mr. A when the sensitivity representation keyword “refreshing” is used, while a hit is found mainly on a young female singer for Mr. B for the same sensitivity representation keyword.

The data may be deleted when a predetermined period has elapsed or the data may be deleted in chronological order.

In the above embodiment, total summation of points may be made in association with the information related to an image.

For example, total point summation may be made per each shooting information item “shooting date/time (season/time zone),” “weather (fine/rainy)” at that time, or “shooting magnification (high/low)” for the same type “field: mountain.” Shooting information may be arranged in layers for the same mountain and total summation of points be made per layer.

While the aforementioned customization is made per individual user, the customization may be made within a specific group (members must be registered in advance), that is, per group such as a specific circle.

In this example, points in specification of an image per member may be totaled within a group and the resulting information may be recorded into a representative PC as in-group customized information.

Keyword retrieval types may be switched between general use, personal use, and group use. That is, customized information for retrieval may be witched between general use, personal use, and group use.

Service forms and use methods to which is applied the method for storing an image, the method for retrieving a registered image and the method for performing image processing on a registered image according to the invention are described below.

For example, as Example 1, retrieval using customized information for personal use of the partner can be used to select a present. When it is specified that the person ho will receive a present likes clothes of a refreshing color, what color “the refreshing color” refers to can be properly selected using customized information and the person's favorite clothes can be selected.

As Example 2, it is possible to use customized information for retrieval for personal use/group use in searching for restaurants on the internet.

As Example 3, customized information can be used to simulate make-up or select cosmetics. Customized information for retrieval for personal use is preferably generated for the types including cosmetics maker, hue, and model.

As Example 4, customized information can be used to select a picture for a formal meeting with a view to marriage. Types of faces are preferably generated as classified by the aspect ratio of a face wearing make-up or ratio of intervals between eyes, nose and mouth.

The method and system for storing an image according to the first and fourth aspects of the invention, the method and system for retrieving a registered image according to the second and fifth aspects of the invention, and the method and system for performing image processing on a registered image according to the third and sixth aspects of the invention are basically constructed as described above. However, the present invention is not limited to the description above. As in the seventh aspect of the invention, the storage method according to the first aspect of the invention, the retrieval method according to the second aspect of the invention, and the image processing method according to the third aspect of the invention as described above may be implemented in the form of image processing programs operating on a computer.

While various embodiments of the method for storing an image, the method and system for retrieving a registered image, the method for performing image processing on a registered image, and the programs for implementing these methods according to the invention have been described in detail, the invention is by no means limited to these embodiments and various changes and modifications can be made in it without departing the spirit and scope thereof.

As described hereinabove, according to the invention, a sensitivity representation keyword concerning an image such as a photographed image, an obtained image, a generated image or the like is set via the type of a photographed subject of an image scene such as a photographed subject, a subject of an image or the like, the sensitivity representation keyword is associated with the image such as the photographed image, the obtained image, the generated image or the like as pertaining information thereof, and the image is stored as a registered image. An operator has only to retrieve a desired registered image to efficiently retrieve a registered image suitable for sensitivity representation information. The operator has only to input sensitivity representation information to retrieve a desired registered image even when he/she do not know the proper nouns of the shooting site and the subject. Image processing to suit the sensitivity representation information is performed so that desired information is readily obtained.

What is claimed is:

1. A method for storing an image which obtains pertaining information of an image by using a first database in which a type of an image scene and a sensitivity representation keyword associated therewith are previously stored and stores said image or its identification information as a registered image together with said pertaining information in a second database, comprising:
extracting a scene in said image and obtaining a type for said image scene when storing said image;
deriving said sensitivity representation keyword referring to said first database by using said type obtained; and
associating the derived sensitivity representation keyword with said image as the pertaining information thereof and storing said image or its identification information in said second database as the registered image.

2. The method for storing an image according to claim 1, wherein
the type for said image scene of said scene obtained when storing said image is also associated with said registered image as pertaining information of said image.

3. The method for storing an image according to claim 1, wherein
said image is a photographed image, obtained image or generated image, said image scene is a photographed subject or a subject of an image, and said scene is a subject.

4. The method for storing an image according to claim 3, wherein
the subject in said photographed image is extracted by using depth information on photographed scene.

5. The method for storing an image according to claim 3, wherein
after extracting the subject in said photographed image, the subject is identified by using depth information from photographing to obtain the type for the photographed subject of said subject.

6. The method for storing an image according to claim 3, wherein
the extraction of the subject in said photographed image is extraction of an area of the subject in said photographed image.

7. A retrieval method for retrieving a desired registered image from among registered images stored by an image storing method which obtains pertaining information of an image by using a first database in which a type of an image scene and a sensitivity representation keyword associated therewith are previously stored and stores said image as a registered image together with said pertaining information in a second database,
said image storing method comprising: when storing said image, extracting a scene in said image; obtaining a type for said image scene; deriving said sensitivity representation keyword referring to said first database by using said type obtained; associating the derived sensitivity representation keyword or the sensitivity representation keyword combined with the type for the image scene with said image as the pertaining information thereof and storing said image or its identification information in said second database as the registered image,
said retrieval method comprising: finding a sensitivity representation keyword that corresponds or approximately corresponds to an input sensitivity representation information or the type of the image scene associated with the sensitivity representation keyword from among the pertaining information of said registered image when retrieving said registered image; and
taking a registered image having the found sensitivity representation keyword or the type of the image scene as the pertaining information out from said second database.

8. A retrieval method for retrieving a desired registered image from among the registered images stored by an image storing method which obtains pertaining information of an image by using a first database in which a type of an image scene and a sensitivity representation keyword associated therewith are previously stored and stores said image as a registered image together with said pertaining information in a second database,
said image storing method comprising; when storing said image, extracting a scene in said image; obtaining a type for said image scene; deriving said sensitivity representation keyword referring to said first database by using said type obtained; associating the derived sensitivity representation keyword with said image as pertaining information thereof and storing said image or its identification information in said second database as the registered image,
said retrieval method comprising: retrieving said registered image in said second database by using a sensitivity representation keyword that corresponds or approximately corresponds to an input sensitivity representation information when retrieving said registered image;
taking out a plurality of registered images having the sensitivity representation keyword as the pertaining information to display on an image display device;
repeating the procedure of adding points for a predetermined period of time for an image or its type selected by a user from among a plurality of registered images displayed at every retrieval;
totaling the added points per image retrieved with an identical sensitivity representation keyword or per type and per said user after said predetermined period of time has elapsed and storing the resulting total points; and
narrowing the images and their types to those having points exceeding a predetermined rate or giving a priority to those images and types for the next and subsequent retrievals.

9. A method for performing image processing on a registered image in which image processing is performed on a called-out registered image obtained by retrieving a desired registered image from among registered images stored by an image storing method which obtains pertaining information of an image by using a first database in which a type of an image scene and a sensitivity representation keyword associated therewith are previously stored and stores said image as a registered image together with said pertaining information in a second database,
setting an image processing condition in association with said sensitivity representation keyword;
storing by the image storing method which, when storing said image, extracts a scene in said image and obtains a type for said image scene, derives said sensitivity representation keyword referring to said first database by using said type obtained, associates the derived sensitivity representation keyword or the sensitivity representation keyword combined with the type for the image scene with said image as the pertaining information thereof and stores said image or its identification information in said second database as the registered image;
when retrieving said registered image, finding a sensitivity representation keyword that corresponds or approximately corresponds to an input sensitivity representation information or the type of the image scene associated with the sensitivity representation keyword from among the pertaining information of said registered image;
taking a registered image having the found sensitivity representation keyword or the type of the image scene as the pertaining information out from said second database;
when performing image processing on the taken registered image, calling an image processing condition associated with a sensitivity representation keyword that corresponds or approximately corresponds to said sensitivity representation information; and
performing the image processing according to the image processing condition.

10. A method for performing image processing on a registered image in which image processing is performed on a called-out registered image obtained by retrieving a desired registered image from among registered images stored by an image storing method which obtains pertaining information of an image by using a first database in which a type of an image scene and a sensitivity representation keyword associated therewith are previously stored and stores said image as a registered image together with said pertaining information in a second database,
setting an image processing condition in association with said sensitivity representation keyword;
storing by the image storing method which, when storing said image, extracts a scene in said image and obtains a type for said image scene, derives said sensitivity representation keyword referring to said first database by using said type obtained, associates the derived sensitivity representation keyword with said image as the pertaining information thereof and stores said image or its identification information in said second database as the registered image;
when retrieving said registered image, retrieving said registered image in said second database by using a sensitivity representation keyword that corresponds or approximately corresponds to an input sensitivity representation information;
taking out a plurality of registered images having the sensitivity representation keyword as pertaining information to display on an image display device;
repeating the procedure of adding points for a predetermined period of time for an image or its type selected by a user from among a plurality of registered images displayed at every retrieval;
totaling the added points per image retrieved with an identical sensitivity representation keyword or per type and per said user after said predetermined period of time has elapsed and storing the resulting total points;
narrowing the images and their types to those having points exceeding a predetermined rate or giving a priority to those images and types for the next and subsequent retrievals;
when performing an image processing on the retrieved registered image, calling an image processing condition associated with a sensitivity representation keyword that agrees or approximately agrees with said sensitivity representation information; and
performing the image processing according to the image processing condition.

11. A retrieval system for retrieving a desired registered image from among registered images, comprising:
a first database in which a type of an image scene and a sensitivity representation keyword associated therewith are previously stored;
means for obtaining a type for said image scene by extracting a scene in said image when storing said image;
means for deriving said sensitivity representation keyword referring to said first database by using said type obtained;
a second database which associates the derived sensitivity representation keyword or the sensitivity representation keyword combined with the type for the image scene with said image as the pertaining information thereof and stores said image or its identification information as the registered image together with said pertaining information; and
registered image retrieval means which finds a sensitivity representation keyword that corresponds or approximately corresponds to an input sensitivity representation information or the type of the image scene associated with the sensitivity representation keyword from among registered images and their pertaining information stored in the second database, and takes a registered image having the found sensitivity representation keyword or the type of the image scene as the pertaining information out from said second database.

12. A retrieval system for retrieving a desired registered image from among registered images, comprising:
a first database in which a type of an image scene and a sensitivity representation keyword associated therewith are previously stored;
means for obtaining a type for said image scene by extracting a scene in said image when storing said image;
means for deriving said sensitivity representation keyword referring to said first database by using said type obtained;
a second database which associates the derived sensitivity representation keyword or the sensitivity representation keyword combined with the type for the image scene with said image as the pertaining information thereof and stores said image or its identification information as the registered image together with said pertaining information;
retrieval means which retrieves said registered image in the second database by using a sensitivity representation keyword that corresponds or approximately corresponds to an input sensitivity representation information when the registered image is retrieved from registered images stored in the second database;
an image display device which takes out and displays a plurality of registered images having the sensitivity representation keyword as the pertaining information; and
evaluation means which repeats the procedure of adding points for a predetermined period of time for an image or its type selected by a user from among said plurality of registered images displayed at every retrieval, totals the added points per image retrieved with an identical sensitivity representation keyword or per type and per said user after said predetermined period of time has elapsed, and stores the resulting total points in said second database as said pertaining information of said registered image, wherein
said retrieval means narrows the images and their types to those having points exceeding a predetermined rate or giving a priority to those images and types for the next and subsequent retrievals.
